(19) United States
(12) Patent Application Publication
(10) Pub. No.: US 2026/0101229 A1
(43) Pub. Date: Apr. 9, 2026

(54) METHODS, ARCHITECTURES, APPARATUSES AND SYSTEMS FOR SECONDARY NETWORK SELECTION FOR DUALSTEER DEVICES

(71) Applicant: InterDigital Patent Holdings, Inc., Wilmington, DE (US)

(72) Inventors: Anuj Sethi, Ottawa (CA); Rocco Di Girolamo, Laval (CA); Michael Starsinic, Newtown, PA (US); Taimoor Abbas, Sainte-Julie (CA); Guanzhou Wang, Brossard (CA); Magurawalage Chathura Madhusanka Sarathchandra, London (GB); Xavier De Foy, Kirkland (CA)

(21) Appl. No.: 18/906,054

(22) Filed: Oct. 3, 2024

(51) Int. Cl. H04W 28/02; H04W 48/18

(52) U.S. Cl. CPC H04W 28/0268; H04W 48/18

(57) ABSTRACT

Methods and systems are provided for a wireless transmit/receive unit (WTRU). A WTRU receives, from a primary network, information indicating a plurality of secondary networks and a network selection policy, wherein the network selection policy comprises one or more trigger conditions for connecting to a secondary network and one or more criteria for selecting a secondary network from the plurality of secondary networks. The WTRU establishes a first PDU session with the primary network. The WTRU detects a trigger condition from the one or more trigger conditions and in response to detecting the trigger condition, the WTRU selects a secondary network based on the one or more criteria. The WTRU performs a registration procedure on the selected secondary network and establish a concurrent second PDU session with the selected secondary network.

### BACKGROUND

The present disclosure is generally directed to the fields of communications, software and encoding, including, for example, to methods, architectures, apparatuses, systems related to secondary network selection for DualSteer Devices.

### SUMMARY

This disclosure relates to secondary network selection for DualSteer Devices. Secondary mobile network (SMN) information and UE Network Selection Policy (UNSP) information are provided by a first network to a wireless transmit/receive unit (WTRU) capable of concurrent connectivity with more than one network. The SMN and UNSP information are utilized by the WTRU to select a second network and establish a concurrent connection with the second network.

In certain representative embodiments, a method performed by a WTRU is provided. The method may comprise receiving, from a primary network, information indicating a plurality of secondary networks and a network selection policy, wherein the network selection policy comprises one or more trigger conditions for connecting to a secondary network and one or more criteria for selecting a secondary network from the plurality of secondary networks. The method may further comprise establishing a first PDU session with the primary network; detecting a trigger condition from the one or more trigger conditions; in response to detecting the trigger condition, selecting a secondary network based on the one or more criteria; performing a registration procedure on the selected secondary network; and establishing a concurrent second PDU session with the selected secondary network.

In certain representative embodiments, a method for establishing network selection policies is provided. The method may comprise transmitting, from a primary network to a first WTRU, information indicating a first plurality of secondary networks and a first network selection policy, wherein the first network selection policy comprises one or more first trigger conditions for connecting to a secondary network and one or more first criteria for selecting a secondary network from the first plurality of secondary networks. The method may further comprise transmitting, from the primary network to a second WTRU, information indicating a second plurality of secondary networks and a second network selection policy, wherein the second network selection policy comprises one or more second triggers for connecting to a secondary network and one or more second criteria for selecting a secondary network from the second plurality of secondary networks and wherein the first network selection policy is different from the second network selection policy.

In certain representative embodiments a WTRU is provided. The WTRU may comprise a processer and a transceiver coupled to the processer. The WTRU may be configured to: receive, from a primary network, information indicating a plurality of secondary networks and a network selection policy, wherein the network selection policy comprises one or more trigger conditions for connecting to a secondary network and one or more criteria for selecting a secondary network from the plurality of secondary networks. The WTRU may be further configured to establish a first PDU session with the primary network; detect a trigger condition from the one or more trigger conditions; in response to detecting the trigger condition, select a secondary network based on the one or more criteria; perform a registration procedure on the selected secondary network; and establish a concurrent second PDU session with the selected secondary network.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a non-roaming dual steering architecture according to one or more embodiments;

FIG. 3 illustrates a Dual steering architecture with roaming in one access according to one or more embodiments;

FIG. 4 illustrates a Dual steering architecture with roaming in both accesses with common VPLMN according to one or more embodiments;

FIG. 5 illustrates Dual steering architecture with roaming in both accesses with two different VPLMNs according to one or more embodiments;

FIG. 6 illustrates an exemplary DualSteer Device according to one or more embodiments;

FIG. 7 illustrates an exemplary procedure for delivery and storage of SMN and UNSP information to a WTRU according to one or more embodiments;

FIG. 8 illustrates a method for selecting a secondary network according to one or more embodiments;

FIG. 9 illustrates a method for establishing network selection policies for a secondary network according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

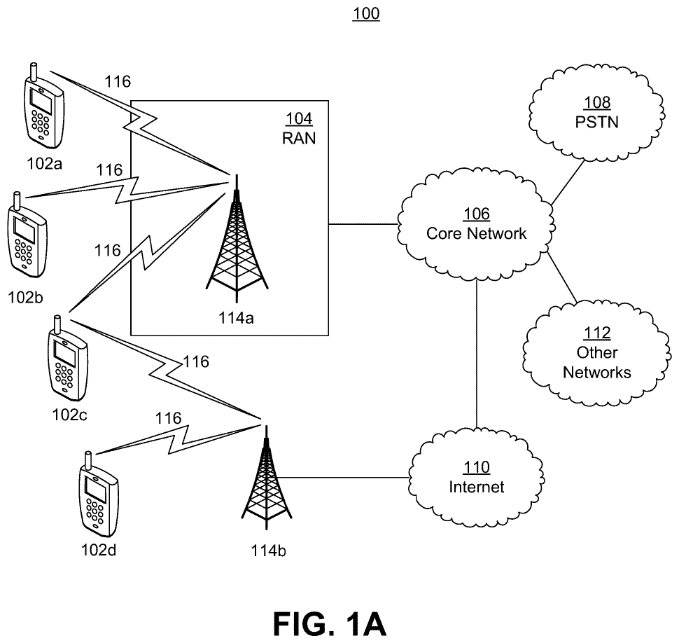

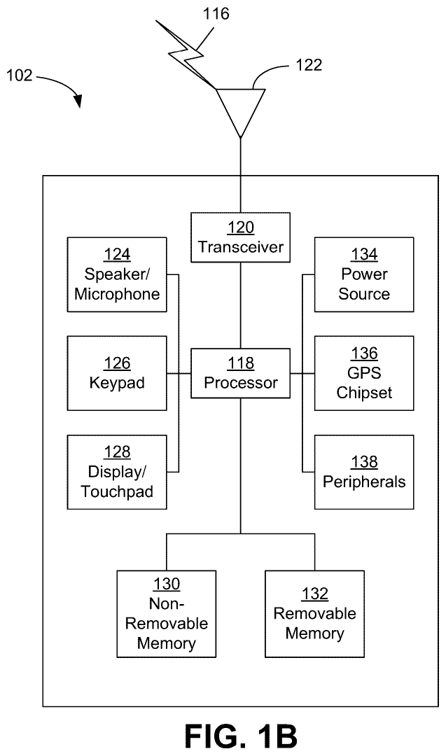

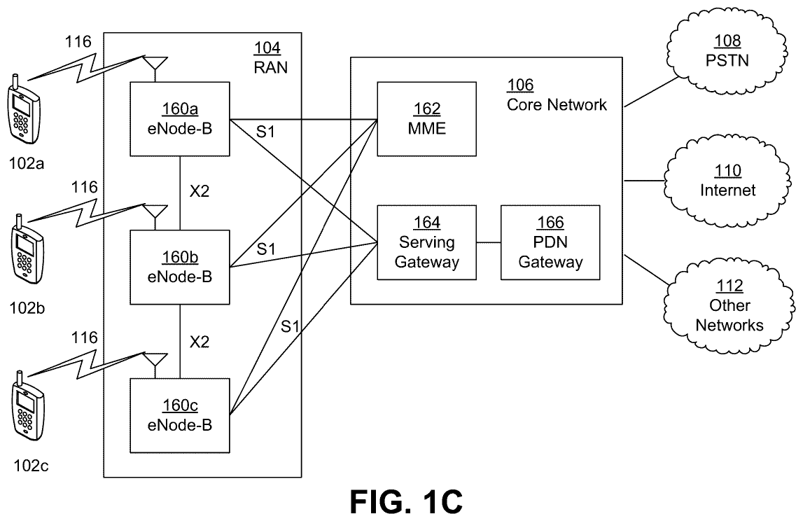

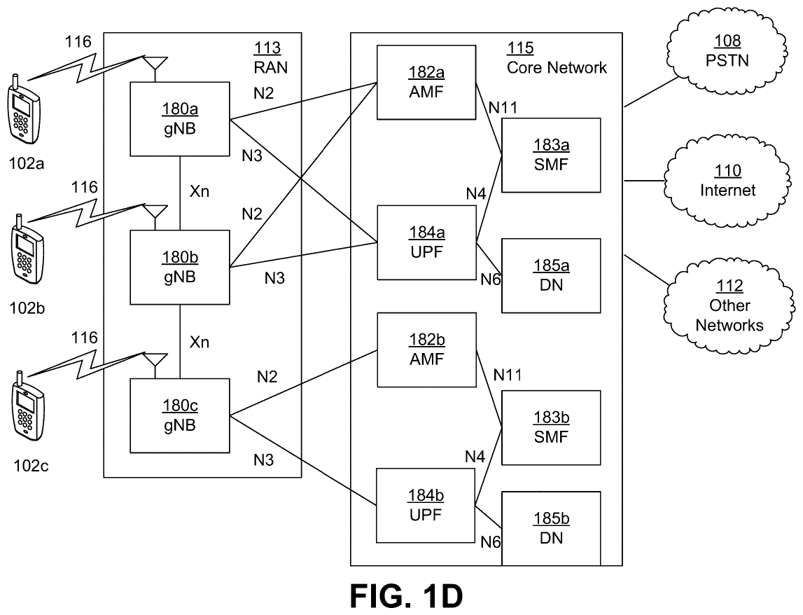

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, WTRUs for Session Management (SM) and Mobility Management (MM) capability for a core network are provided. A WTRU may send the WTRU MM Core Network Capability information to the Access and Mobility management Function (AMF) during the Initial Registration procedure and Mobility Registration Update procedure, within a message (e.g., a Non-Access Stratum (NAS) message). Similarly, a WTRU may include its Core Network Capability (e.g., 5GSM Core Network Capability) in PDU Session Establishment/Modification Requests. These latter messages include the WTRU's Access Traffic Steering, Switching and Splitting (ATSSS) capabilities.

In certain representative embodiments, WTRUs may be configured to perform registration to a network if they need to access services requiring registration. In order to perform this registration, the WTRU may perform a series of steps: Public Land Mobile Network (PLMN) selection or Standalone Non-Public Network (SNPN) selection—procedure by which a WTRU may select a mobile network. This network may be a public network or a non-public network. The WTRU may follow rules to determine how to select from the available networks at a given location, and to determine when to look for higher priority networks; Cell selection/reselection—procedure by which WTRU “camps” on a cell; Registration—procedure to inform network about the WTRU presence and provide some coarse location information and capability exchange and negotiations.

In certain representative embodiments, carrier aggregation may be provided over a single 3GPP access (for example New Radio (NR) or Long Term Evolution (LTE)) but may allow the WTRU to receive over two or more cells. The cells may be each on a different frequency carrier. The use of the two cells may be managed entirely in the Radio Access Networks (RANs).

In certain representative embodiments, WTRUs also support Dual Connectivity (DC). DC may allow a WTRU to receive/transmit over two 3GPP accesses (or 3GPP access legs). For example, the accesses may be NR (gNB) or LTE (eNB). In 5G, some deployments may have one leg over LTE and a second leg over NR. However, other deployments of DC may also support two legs over NR. In this case, the two legs may be on different bands (e.g., FR1 and FR2). In order to employ DC, a WTRU would need the Radio Frequency (RF) front end to support both accesses. In dual connectivity, one leg may be the master leg (and part of a Master Cell Group (MCG)), and the other leg may be the secondary leg (and part of a Secondary Cell Group (SCG))

For the PLMN plus PLMN/NPN scenarios, the two networks may be managed by the same operator or by different operators (assumed to have a business agreement among them).

In certain representative embodiments, 3GPP may support a plethora of mechanisms that enable traffic steering, switching and splitting between a 3GPP access network (e.g., E-UTRA or NR) and a non-3GPP access network (e.g., WiFi) since 4G. One such mechanism may be an ATSSS feature.

In certain representative embodiments, a DualSteer WTRU Device may support traffic steering and switching of user data (for different services) across two 3GPP access networks; it can be (a) a single UE WTRU, in case of non-simultaneous data transmission over the two networks, or (b) two separate UEs in a WTRU in case of simultaneous data transmission over the two networks. The subscriber of the DualSteer Device has two subscriptions/Subscription Permanent Identifiers (SUPIs), sharing one subscription profile from the same operator. For any particular service, at any given time, the DualSteer Device may transmit all traffic of that service using only a single 3GPP access network.

In certain representative embodiments, two 3GPP access types (e.g., NR, Non-Terrestrial NR, E-UTRA) and the network types (e.g., Home PLMN (H-PLMN), Visitor PLMN (V-PLMN), Private Network Instance-Non-Public Network (PNI-NPN)) the 3GPP access networks may be connected to.

In certain representative embodiments, a DualSteer WTRU device may comprise at least one of (a) a “DualSteer device” that uses two SUPIs from the same operator for accessing two separate 3GPP access networks, where each SUPI may be used to connect to only one of the 3GPP access networks at any given time, (b) a “DualSteer device” that sends its user data over two 3GPP access networks belonging to the same PLMN, either non-simultaneously or simultaneously, or (c) a “DualSteer device” that sends its user data over two 3GPP access networks belonging to two different PLMNs, either non-simultaneously or simultaneously. In the case of non-simultaneous data transmission over two networks, a “DualSteer device” may comprise a single UE. In the case of simultaneous data transmission, a “DualSteer device” may comprise two separate UEs.

In case of simultaneous data transmission, the data over two separate networks may belong to different services (or different Service Data Flows).

At any given point of time, all traffic of a single service may be sent over a single access network, i.e., no service data splitting.

Through this disclosure, the term Mobile Network (MN) may be used to refer to a mobile network of any type, including Public Land Mobile Network, Non-Private Network (NPN), Standalone NPN (SNPN), Public Network Integrated NPN (PNI-NPN), etc.

Through this disclosure, the term Primary mobile network (PMN) may be used to refer to a home mobile network or visited mobile network. It may be the mobile network over which a WTRU first registers and establishes the first communication link.

Through this disclosure, the term Secondary mobile network (SMN) may be used to refer to the mobile network, which is used by the WTRU for the secondary (non-primary) communication connection with the mobile network.

Through this disclosure, the term PLMN selection may be used to refer to a legacy PLMN selection procedure.

Through this disclosure, the term Primary MN selection may be used to refer to a mobile network selection procedure that is tailored to find mobile networks for the primary communication connection, the first mobile network with which the WTRU may do registration. The WTRU may need a separate subscription per registration/context it establishes with the core network i.e. for the primary mobile network, the WTRU may use one of its subscription which could be internally termed as primary subscription.

Through this disclosure, the term Secondary MN selection may be used to refer to a mobile network selection procedure that is tailored to find Secondary mobile networks. The WTRU may need a separate subscription per registration/context it establishes with the core network i.e. for the secondary mobile network, the WTRU may use one of its subscription which could be internally termed as secondary subscription. The WTRU may have multiple subscriptions to support concurrent connection to multiple networks.

Through this disclosure, the term SMN information (SMN Information) may be used to refer to information related to secondary mobile networks e.g., SMN identifier, priority of the SMN in the list of SMNs, supported access technologies by the SMNs, validity information (time and location validity), supported slices etc.

Through this disclosure, the term UE/WTRU Network selection policy information (UNSP Information) may be used to refer to information provided by the home operator to the WTRU to assist in primary and secondary network selection e.g., PMN validity information (time/location/service validity) if met may allow the WTRU which is successfully registered with the PMN and is capable of concurrent connectivity to multiple networks to use the SMN information for secondary network selection, restrictions if selected SMN may be equivalent PLMN of the PMN, PMN successful registration required/or not required before SMN selection, Periodic search enabled and periodicity for SMN search while camped on the PMN only, Higher priority search for SMN as per the SMN selection information feature (enabled/disabled) along with the higher priority search duration, and Slice unavailability/rejection on the PMN as the trigger for the SMN selection feature (enabled/disabled).

In certain representative embodiments, an AMF may use the N14 interface for AMF re-allocation and AMF to AMF information transfer. This interface may be either intra-PLMN or inter-PLMN (e.g., in the case of inter-PLMN mobility).

At inter PLMN mobility, the source AMF may select an AMF instance(s) in the target PLMN by querying target PLMN level Node Registration Function (NRF) via the source PLMN level NRF with target PLMN ID. The target PLMN level NRF may return an AMF instance address based on the target operator configuration. After the Handover procedure the AMF may select a different AMF.

In certain representative embodiments, a DualSteer architecture may be based on providing a common anchor (UPF) and session management function (SMF) inside the 5GC for the DS traffic from both 3GPP access networks.

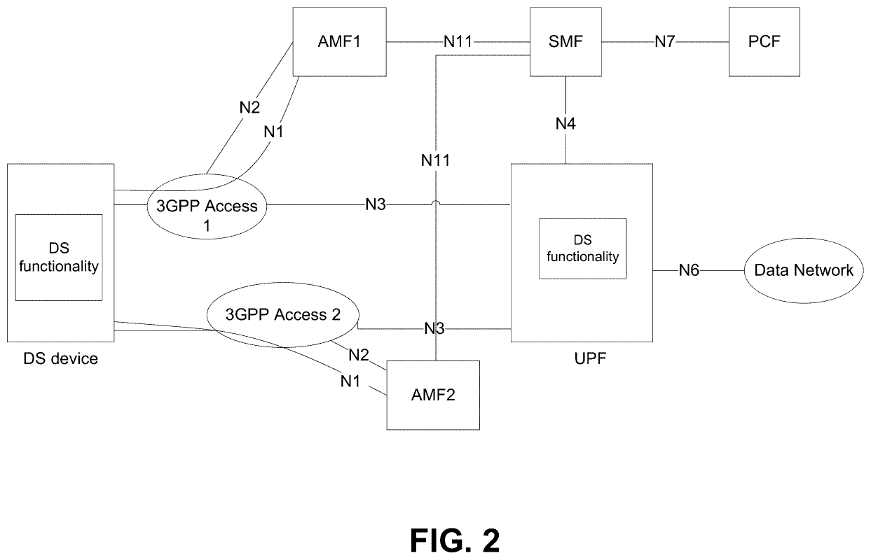

FIG. 2 illustrates a non-roaming dual steering architecture according to one or more embodiment. This architecture may allow a WTRU with DualSteer capability to connect to two separate 3GPP access networks simultaneously. The WTRU establishes PDU sessions, each associated with a different access network. Two separate Access and Mobility Management Functions (AMFs) manage the mobility and session context for the WTRU on their respective networks. A single Session Management Function (SMF) controls the overall PDU sessions and traffic steering for the WTRU across both access networks. User plane data is anchored at a User Plane Function (UPF), which routes traffic between the data network and the UE through one or both access networks as directed by the SMF.

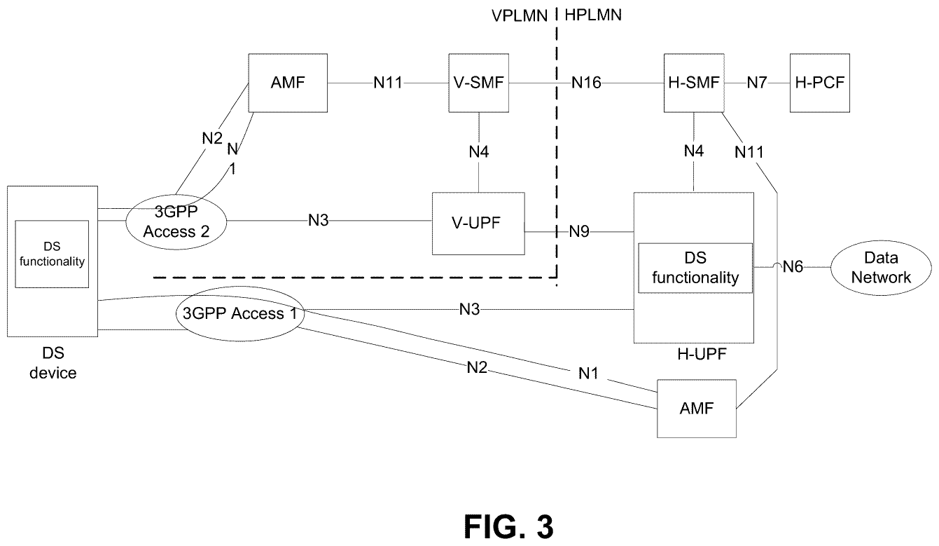

FIG. 3 illustrates a Dual steering architecture with roaming in one access according to one or more embodiment. A WTRU with DualSteer functionality establishes connections with two distinct networks: the home public land mobile network (HPLMN) through 3GPP Access 1 and a visited public land mobile network (VPLMN) through 3GPP Access 2.

In the VPLMN, the WTRU may connect to a first AMF. User plane data is anchored at two UPFs: the V-UPF in the VPLMN and the H-UPF in the HPLMN. Traffic is routed between the WTRU and the data network through either or both UPFs as directed by the SMFs.

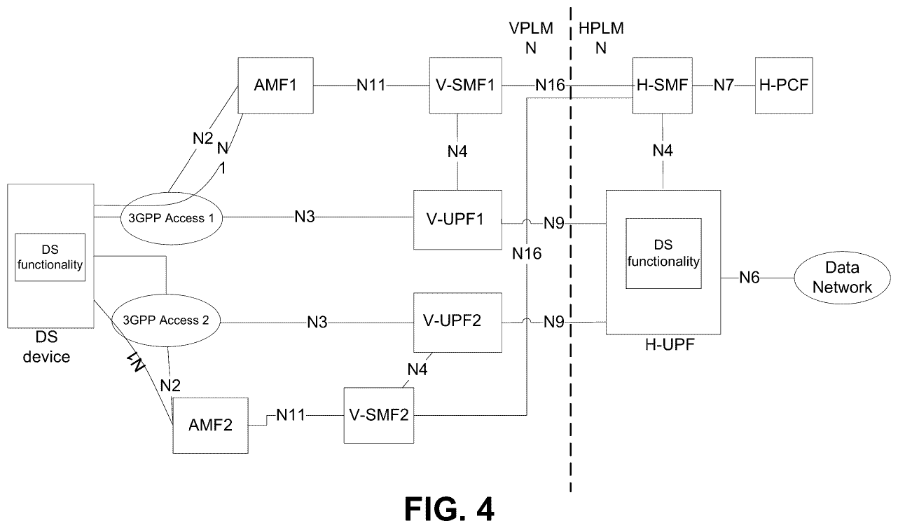

FIG. 4 illustrates a Dual steering architecture with roaming in both accesses with common VPLMN according to one or more embodiment. A WTRU with DualSteer functionality establishes connections with two distinct 3GPP access networks (3GPP Access 1 and 3GPP Access 2) in the same VPLMN. Two separate AMFs manage the mobility and session context for the WTRU on their respective access networks (AMF1 for 3GPP Access 1, AMF2 for 3GPP Access 2). User plane data is anchored at two V-UPFs (V-UPF1 and V-UPF2) located in the VPLMN and one H-UPF located in the HPLMN. Traffic is routed between the WTRU and the data network through any of these UPFs as directed by the SMFs.

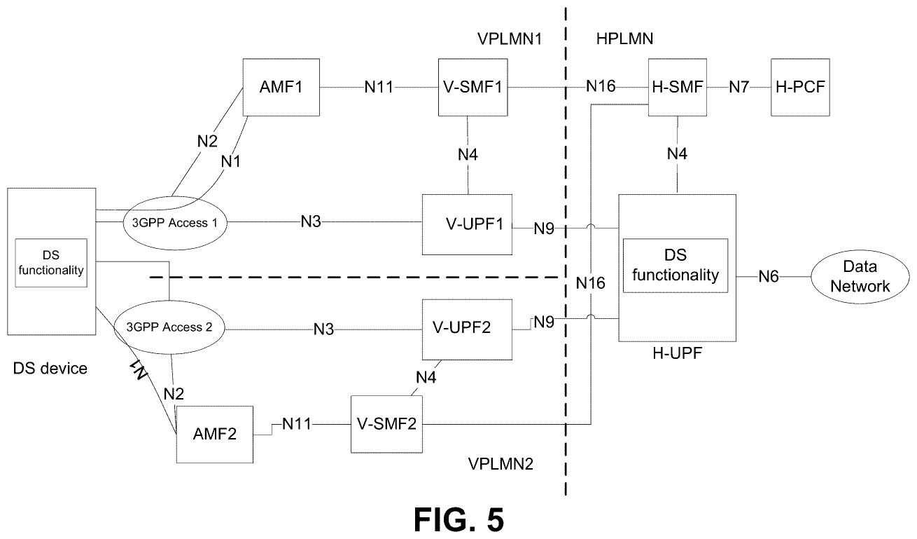

FIG. 5 illustrates Dual steering architecture with roaming in both accesses with two different VPLMNs according to one or more embodiment. A WTRU may establish connections with two distinct 3GPP access networks (3GPP Access 1 in VPLMN1 and 3GPP Access 2 in VPLMN2).

Each VPLMN has its dedicated Access and Mobility Management Function (AMF) and Session Management Function (V-SMF), responsible for managing WTRU's mobility and session context in their respective networks. Traffic flows between the WTRU and the Data Network through either V-UPF or H-UPF as directed by the SMFs.

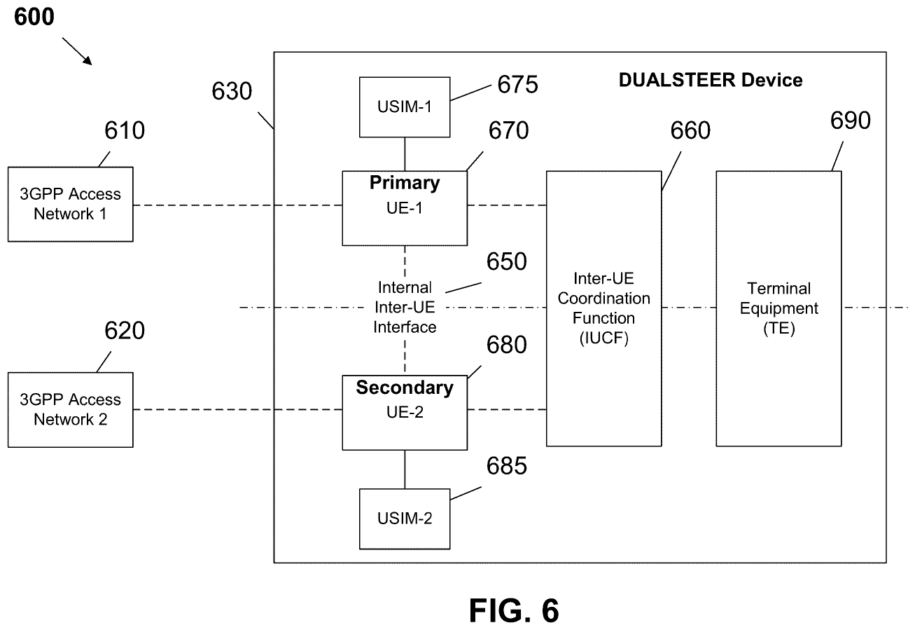

FIG. 6 illustrates an exemplary DualSteer Device 630 according to one or more embodiments. The DualSteer device 630 may be the WTRU 102 of FIG. 1B that has DualSteer capabilities. In certain representative embodiments, a UE may have two separate UEs and USIMs. For example, each UE may provide one or more functionalities of a UE (e.g., at least one of radio transmission, radio reception, baseband signal processing, access to USIM, access to CP stack, access to UP stack, combinations of the same, or the like). A common Terminal Equipment (TE) may be provided (as shown, for example, in FIG. 6). In certain representative embodiments, two separate TEs corresponding to two UEs may be provided. An internal inter-UE interface between two UEs may be provided. The internal inter-UE interface may be configured to allow two UEs to exchange information. In certain representative embodiments, two UEs may exchange information through a higher layer “Inter-UE Coordination Function (IUCF)”. Two UEs may be identified by two unique device identifiers such as IMEIs. An additional ID called DualSteer specific UE ID (DS-specific-UE-ID) may be used to interlink the Primary and Secondary UE in a DualSteer device.

In certain representative embodiments, as illustrated in the example of FIG. 6, a system 600 is provided. The system 600 may include a DualSteer device 630 configured to communicate with a first 3GPP access network 610 and/or a second 3GPP access network 620. The DualSteer device 630 may include a first or primary UE 670 and a second or secondary UE 680. The first or primary UE 670 and the second or secondary UE 680 may communicate, e.g., via an internal inter-UE interface 650. The first or primary UE 670 may have a first USIM 675. The second or secondary UE 680 may have a second USIM 685.

In some embodiments, an Inter-UE Coordination Function (IUCF) 660 may be provided. The IUCF 660 may be provided in the higher layer. The IUCF 660 may be part of a TE 690. The communication between UEs or between the UE and the IUCF 660 may use AT commands. Two UEs may be identified by two unique device identifiers such as International Mobile Equipment Identities (IMEIs).

Both UEs may have a separate subscription for registering to mobile network. Primary UE may Register to a PLMN at first, and the Secondary UE 680 may Register only when it is triggered by the Primary UE directly or via the IUCF layer 260. A UE in a DualSteer capable WTRU may include the Information of primary or secondary UE as part of its Registration Request message and send it to the network.

In certain representative embodiments, a Non-Public Network (NPN) may be a 5GS deployed network which is for non-public use. An NPN may be either: a Stand-alone Non-Public Network (SNPN), i.e. operated by an NPN operator and not relying on network functions provided by a PLMN, or a Public Network Integrated NPN (PNI-NPN), i.e., a non-public network deployed with the support of a PLMN.

In certain representative embodiments, a Non-public networks (NPN) may be for the use of a private entity such as an enterprise or a factory. A SNPN may be identified by a combination of PLMN ID and Network Identifier (NID), where the PLMN ID may be e.g. reserved PLMN IDs for private networks (e.g., with Mobile Country Code=999).

In certain representative embodiments, The NG-RANs of the SNPN may broadcast the combination of PLMN IDs and NIDs. A WTRU operating in SNPN access mode reads the broadcast system information for available (PLMN ID+NID)'s and selects the SNPN for which it has subscription and credentials.

In certain representative embodiments, a PNI-NPN may be a Non-Public Network made available using PLMN infrastructure/resources, e.g., a PLMN network slice. A group of PLMN users which are allowed to access a certain PNI-NPN may be referred to as a Close Access Group (CAG) and a CAG is identified by a CAG identifier. CAG users may only access a PNI-NPN from a cell that supports CAG access, which is called a “CAG cell”. A CAG cell broadcasts a list of CAG identifiers that it supports. A CAG WTRU may be configured by the network with a list of CAGs that it can access (Allowed CAG List). When a CAG WTRU detects a CAG cell, it can only select/access the CAG cell if at least one of the broadcasted CAG identifier(s) matches one of the CAG identifiers in its Allowed CAG List.

In certain representative embodiments, the Network selection may be the process by which the user equipment (UE/WTRU) performs the radio scan to check the availability of the (MN) mobile networks (i.e., PLMNs or NPNs) at its current location and try to register to the MN (mobile network).

In certain representative embodiments, at Switch on or following recovery from lack of coverage, the WTRU may select the MN that the WTRU last registered to (if it's available) using the supported access technology and perform registration procedure. If the MN that the WTRU last registered to is not available, then the WTRU may scan all RF channels in the supported access technologies frequency bands according to its capabilities to find available MNs. On each carrier (i.e., channel), the WTRU may search for the strongest cell and read its system information. The system information is read in order to find out which MN the cell belongs to. If there is no last registered Mobile Network, or registration is not possible due to the Mobile Network being unavailable or registration failure, the WTRU may follow procedures depending on its mode of operation i.e. PLMN vs SNPN selection mode and WTRU's network selection operation mode i.e. Automatic vs Manual network selection mode.

In certain representative embodiments, scenarios are provided that may require a WTRU to be concurrently connected to two different mobile networks. Such scenarios may include: Multi-network connectivity and service delivery across operators allows a WTRU to consume services from two different networks at the same time; Enhancements for network slicing covers the case where a WTRU connects to an additional network to be able to access a required network slice which is not available in the current registered PLMN; Access to localized networks allows a WTRU to additionally connect to a localized network to consume content or services which are only available in this network, the localized network may be a SNPN or PNI-NPN; A DualSteer Device may supports traffic steering and switching of user data (for different services) across two 3GPP access networks; it may be (a) a single WTRU, in case of non-simultaneous data transmission over the two networks, or (b) two separate WTRUs in case of simultaneous data transmission over the two networks.

In certain representative embodiments, “what” aspect of the availability of connection on two or more different mobile networks are provided. In certain representative embodiments, “how” aspect i.e. the selection aspects of the (second) secondary mobile network are provided. The objective of current mobility selection mechanisms may be to select a mobile network to provide basic connectivity for a WTRU. However, for Multi-network connectivity, localize services, and DualSteer, the objective of the secondary mobile network may not be to provide basic connectivity. As a result, using the current mobility selection mechanisms for the (second) secondary mobile network, may result in selecting a second mobile network that is not useful for traffic switching or which is not the best network to provide localized services.

In certain representative embodiments, 5G system are provided that are enhanced with respect to selection of the secondary/additional network (PLMN/NPN) taking into considerations priorities, dependency between the primary and secondary mobile network, enhancement to 5G network selection behaviour when primary/secondary network becomes unavailable, periodic attempts to find a higher priority network and other restrictions and validity of the information for network selection.

In certain representative embodiments, network selection for WTRU's capable of concurrently connected to multiple mobile networks are provided.

In certain representative embodiments, a Network (PLMN/SNPN) selection is provided.

In certain representative embodiments, the concept of secondary mobile network (SMN) information and WTRU Network Selection Policy (UNSP) Information provided by the home operator to the WTRU's which are capable of concurrently communicating/registering with more than one mobile network i.e. PLMN or NPN are provided. The SMN and UE/WTRU Network Selection Policy (UNSP) information may be used by the WTRU to assist in secondary network selection, establishing the dependency between the primary and secondary mobile network selection, behaviour of the WTRU when the WTRU loses the coverage of the secondary mobile network, or WTRU behaviour when it's not camped on the highest priority secondary mobile network or when the WTRU is camped in limited service mode on the secondary mobile network, or the WTRU may be served by the secondary mobile network and the Quality of Experience (QoE) drops below the threshold. The SMN and UNSP information is used by the WTRU to further establish restrictions on network selection, validity conditions which are applicable to the PMN or SMN for network selection and usage. The SMN and UNSP information is used by the WTRU to establish its behaviour when desired network slices are not available on the primary mobile network.

In certain representative embodiments, a WTRU may perform at least one of the following steps.

At step 1, the WTRU may receive from a first Mobile Network, SMN (secondary mobile network) and UNSP (WTRU network selection policy) information, which may be used by the WTRU to assist with the secondary mobile network selection procedure. Alternatively, the SMN/UNSP information may be provided via other NAS signaling messages e.g., a Service Accept message, a PDU Session establishment accept message, or a PDU session modification response message, a WTRU Configuration Update Command, WTRU parameter update request message, Steering of Roaming message (SOR Container) or DL NAS Signaling message.

At step 2, the WTRU may store the provided SMN and UNSP information from the network function (AMF) in the WTRU. The SMN/UNSP information may be stored in the non-volatile memory in the WTRU, or in Elementary Files (EFs) maintained in the USIM.

At Step 3, the WTRU on detection of the SMN selection trigger may use the available SMN and UNSP information to start SMN selection procedure. Some exemplary SMN selection triggers may be switch/power on the WTRU; request from the upper layers e.g. request to establish the MA PDU Session using DualSteer functionality; request from a coordination function within a WTRU that the manages multi-WTRU, multi-connectivity functionality; request to access hosting network (SNPN); slices unavailability on the PMN and corresponding feature is enabled in the UNSP information (i.e. Slice unavailability/rejection on the PMN as the trigger for the SMN selection feature is enabled); PMN validity info (Time/location/Service) is met, the time/location/service validity information is met for the successfully registered PMN i.e., the time window is valid, or location is part of valid cells/Tracking Area Codes (TACs)/Tracking Area Identities (TAIs), or service is supported by the network e.g. DualSteer support indicated by the PMN; Manual SMN selection request from the user of the WTRU; detecting that a type of application has started; detecting that a QoE measurement is below a threshold; detecting that measurement of the quality if the connection to the PMN is below a threshold; detecting a high network load and/or network congestion; determining to use DualSteer for a non-DS MA-PDU session.

At step 4, the WTRU may select the SMN from the list of SMNs present in the SMN information if available and allowable (An allowable SMN is not part of any valid forbidden lists of PLMNs/SNPNs maintained by the WTRU and if the SMN has validity information stored in the SMN information, an allowable SMN would be the one which satisfies the validity conditions i.e. time and location validity is met) using one or more rules as follows: (a) select the highest priority SMN/access technology combination from the list of SMNs, (b) if the flag “PMN equivalent PLMNs restriction” as per the UNSP information is set to True, the SMN selection may ensure that only SMNs which are part of the equivalent PLMNs to PMN may be considered as selection candidates for SMN selection, or (c) if the trigger for the SMN selection was because of slice unavailability on the PMN, the SMN selection candidates may be the SMNs which support desired slices (i.e., slices which were not available or rejected on the PMN.

At step 5, the WTRU may perform the registration procedure on the selected SMN (i.e. PLMN or SNPN) and may be considered successfully registered on the SMN if following conditions are met: the WTRU was able to find a suitable cell of the SMN to camp on and the registration request from the WTRU has been accepted in the registration area of the cell on which the WTRU is camped.

In certain representative embodiments, solutions are provided to enable a WTRU to be able to concurrently connect to multiple networks. Solutions may be provided in the following areas: delivery and storage of the SMN and UNSP information to the WTRU; secondary mobile network (SMN) selection and registration procedure; periodic search for SMN while camped on PMN or limited mode camping on the SMN; and periodic attempts to find and select the higher priority SMN.

In certain representative embodiments, a WTRU may receive the SMN and UNSP information from the mobile network either during the primary network or secondary network registration procedure (or via other NAS signaling messages).

The WTRU may receive secondary mobile network (SMN) information as a list of secondary mobile networks. For each SMN in the list of SMNs, the SMN information may include one or more of the following: SMN Identifier (SMN ID), Priority, Supported Access Technologies, Validity information, and Supported network slices. The SMN Identifier may comprise an identifier for the SMN, e.g., a Mobile Country Code (MCC) and a Mobile Network Code (MNC) assigned to a PLMN, or the combination of PLMN ID and NID assigned to an SNPN. The type of the SMN may be derived from its identifier if it's a PLMN or a non-public network (NPN). The Priority may comprise a list with the first entry having the highest priority for the purpose of SMN selection. The Supported Access Technologies may comprise an indication if the SMN supports one or a combination of the following: NR, LTE, and satellite. For satellite access, the information may further include details as to the type of satellite: LEO, MEO, or GEO. The Validity information may comprise time and location information. The Time validity information may include information like time windows (start and end time), recurrence pattern and recurrence end time. The recurrence pattern indicates how often the time window is repeated e.g., every day, weekdays, every week, every 2 weeks, every month etc. The recurrence end time indicates the time when the repetition of the time window ends. The Location validity information may include location information e.g. geofencing area, list of TACs/TAIs, list of Cells etc. The Supported network slices may be identified by a list of Single Network Slice Selection Assistance Information (S-NSSAI).

The WTRU may receive UE/WTRU Network selection policy (UNSP) information which may assist the WTRU in selection of secondary mobile network. The UNSP information may include one or more of the following: PMN validity info (Time/location/Service); PMN equivalent PLMNs restriction (True/False); PMN Successful registration (True/False); periodic search and periodic search timer duration (True/False); power on SMN selection (True/False); higher priority search for SMN, feature enabled/disabled; slice unavailability/rejection on the PMN as the trigger for the SMN selection feature enabled/disabled; DualSteer upgrade for non-DS MA-PDU session enabled/disabled.

The PMN validity info may comprise Time/location/Service: The time and location validity information for the primary mobile network (PMN), which when met may enable the WTRU to select secondary mobile network as per the SMN information; Time validity information could contain information like time windows (start and end time), recurrence pattern and recurrence end time. The recurrence pattern indicates how often the time window is repeated e.g., every day, weekdays, every week, every 2 weeks, every month etc. The recurrence end time indicates the time when the repetition of the time window ends; Location validity information could contain location information e.g. geofencing area, list of TACs/TAIs, list of Cells etc. Services Status—Services which when enabled on the PMN would enable the WTRU to trigger SMN selection as per the SMN information. The Primary mobile network has accepted certain services for the WTRU e.g. support for DualSteer functionality has been accepted by the PMN, may be the pre-condition for the WTRU to enable SMN selection. Threshold or indicator for a high network load or network congestion level. A threshold would apply to measurements by the WTRU or measurements by the network that are communicated to the WTRU. An indicator would trigger SMN selection when the WTRU determines a high network load or network congestion level, or when the WTRU is notified by the PMN of a high network load or network congestion level.

The PMN equivalent PLMNs restriction (True/False): The SMN selection may take into consideration the ePLMNs from PMN along with the SMN information for priority and validity to select SMN. If this flag is set to True, a valid SMN has to be an equivalent PLMN to the PMN, the WTRU is restricted to selecting only ePLMNs to PMN as SMNs. The same logic may be extended to the SNPNs; PMN Successful registration (True/False): The flag requires successful registration on the PMN before the WTRU can select and register on the SMN as per the provided SMN information.

The periodic search and periodic search timer duration (True/False): If the flag is true, the WTRU may periodically search for the SMN while camped on the PMN or camped on any available cell which is providing limited services. The periodicity is determined as per the periodic search timer duration. The periodic search timer can be configured with the provided periodic search timer duration and expiration of the timer can be used as the trigger for the initial search for the SMN once the WTRU has successfully registered with the PMN.

The power on SMN selection (True/False): If the flag is true the WTRU may search and select the SMN at power on, if PMN successful registration flag is true, the WTRU may ensure registration is successful on the PMN before attempting registration on the SMN.

The higher priority search for SMN, feature enabled/disabled: If the feature is enabled, the WTRU while camped on the SMN may periodically search for the highest priority SMN if not already camped on the highest priority SMN as per the SMN information (the first entry in the SMN information has the highest priority). If enabled, the periodicity of the higher priority search for SMN may be based on the higher priority search duration also included in the UNSP information.

The slice unavailability/rejection on the PMN as the trigger for the SMN selection feature enabled/disabled: If the feature is enabled, if the slice (S-NSSAI) is not available or supported on the PMN and there are SMNs in the SMN information which support the required slice (S-NSSAI), the WTRU may trigger SMN selection and registration on SMN which supports the required slice.

The DualSteer upgrade for non-DS MA-PDU session enabled/disabled: if the feature is enabled, if an MA-PDU session is requested but cannot be fully provided (e.g., there is no available second access), the WTRU may trigger SMN selection for the purpose of modifying the MA-PDU session to be a DualSteer MA-PDU session. If the WTRU is already camped on a suitable SMN, the WTRU may or may not trigger SMN selection based on other flags (e.g., higher priority search for SMN).

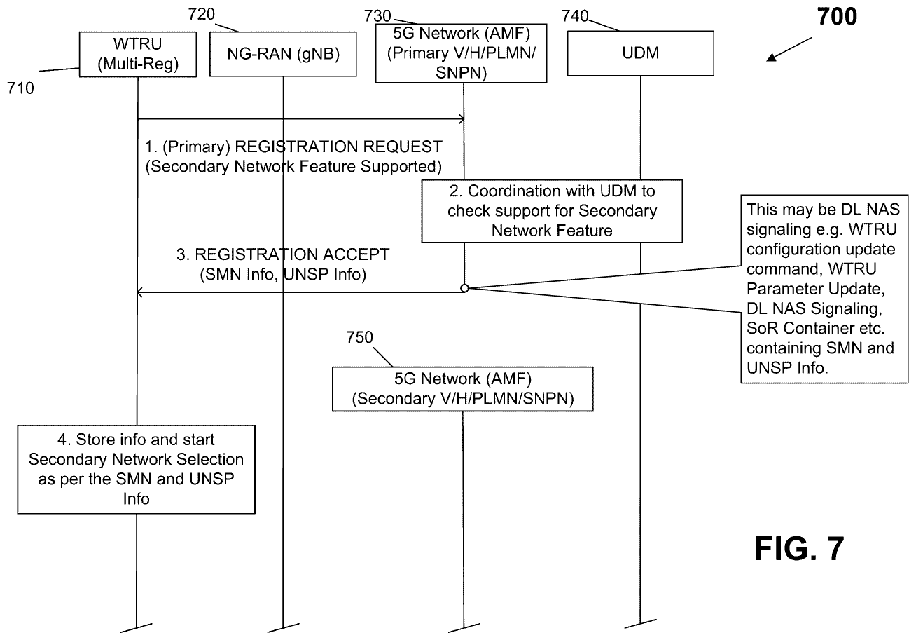

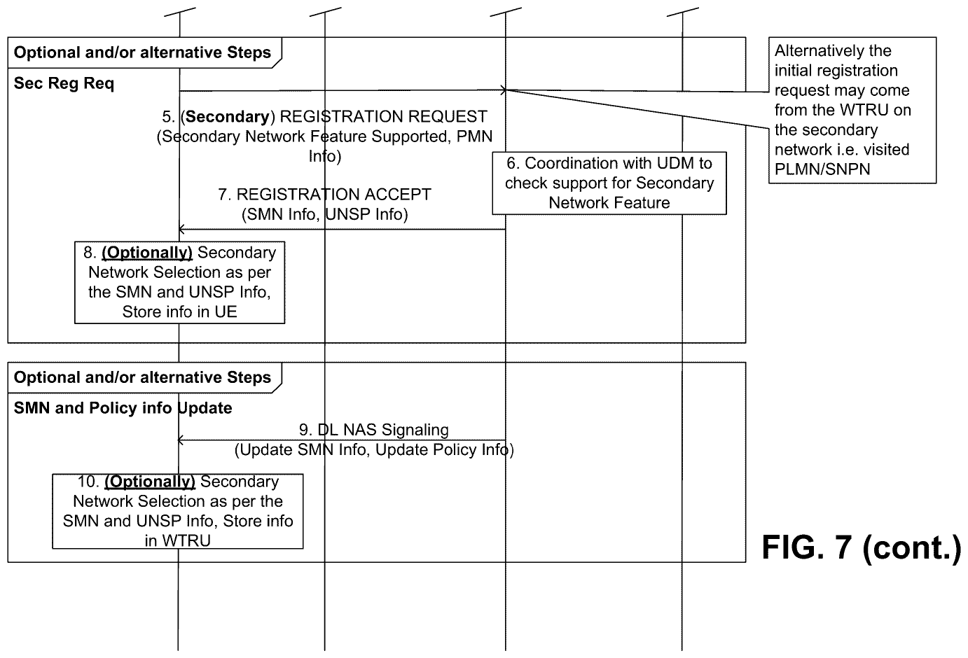

FIG. 7 illustrates an exemplary procedure 700 for delivery and storage of SMN and UNSP information to a WTRU 710 according to one or more embodiments. The WTRU 710 may be capable of concurrently communicating/registering with more than one mobile network i.e. PLMN or NPN. The WTRU 710 may be similar to any of the WTRUs 102 of FIGS. 1A-1D or the DualSteer device 630 of FIG. 6.

The procedure 700 may include step 1. At step 1, the WTRU 710 may send a Registration Request message (e.g., a NAS Registration Request message) to a network 730. The network 730 may include gNB 720. The network 730 may be similar to the network 106 or network 115 of FIGS. 1A-1D. The WTRU 710 may be capable of concurrently connecting to multiple mobile networks. In the registration request message the WTRU 710 may include additional parameters “secondary network feature support”, indicating support for the secondary network selection feature. The registration procedure may be triggered by the primary UE i.e. the first registration procedure triggered by the UE which is capable of concurrently connecting to multiple mobile networks. The network may be a visited PLMN, home PLMN or an SNPN.

The procedure 700 may include step 2. At step 2, the network function (AMF) 730 coordinates with a UDM 740 to check for the support of “secondary network selection feature”. The AMF 730 may be similar to any of AMFs 182a, 182b of FIG. 1D.

The procedure 700 may include step 3. At step 3, If the secondary network selection feature is supported by the network 730 as well as by the WTRU 710, the network function (AMF) may respond with a registration accept message (e.g., a NAS registration accept message), including SMN and UNSP information. The contents of the SMN and UNSP information has been described above. Alternatively the SMN/UNSP information may be provided via other NAS signaling messages e.g., a Service Accept message, a PDU Session establishment accept message, or a PDU session modification response message, a WTRU Configuration Update Command, WTRU parameter update request message, Steering of Roaming message (SOR Container) or DL NAS Signaling message.

The procedure 700 may include step 4. At step 4, the WTRU 710 may store the provided SMN and UNSP information from the network function (AMF) 730 in the WTRU 710. The SMN/UNSP information may be stored in the non-volatile memory in the WTRU 710, or in Elementary Files (EFs) maintained in the USIM. The WTRU 710 may check if SMN selection is required, the decision and trigger conditions for SMN selection are described. At this point in the procedure, the WTRU 710 may wait for detection of trigger to start SMN Selection. Example of what events may be detected by the WTRU 710 and trigger SMN Selection are described herein. When the WTRU 710 selects an SMN, it may trigger step 5 of this procedure.

The procedure 700 may include step 5. At step 5, the difference between the step 5 and step 1 may be that in the step 5 the registration procedure may be triggered to a secondary network 750. The secondary network 750 may be similar to the network 730. The WTRU 710 has already selected the secondary network 750 and sends a NAS registration request message. Alternatively, the NAS message may be a service request message, PDU session establishment message, PDU session modification request message or other UL NAS signaling message. In the registration request or other UL NAS message the WTRU 710 may include additional parameters “secondary network feature support”, indicating support for the secondary network selection feature. It may be possible that the WTRU 710 does not have the stored SMN/UNSP information (i.e., the registration on the PMN did not yield SMN/UNSP information, or the feature was not enabled while the WTRU 710 was registered on the PMN), the WTRU 710 may select any secondary network and triggers the registration or other NAS procedures to request the network to provide the latest SMN/UNSP information.

The procedure 700 may include at least one of steps 6, 7, or 8. At steps 6, 7, or 8, the secondary network 750 may coordinate with the UDM 740 to check if the feature is supported, and if supported may share the latest SMN/UNSP information with the WTRU 710. The WTRU 710 on reception of the SMN/UNSP information may re-evaluate the highest priority SMN and if it's not already camped on the highest priority SMN, it may trigger SMN selection.

The procedure 700 may include step 9. At step 9, if and when there is a change in the SMN/UNSP information, the secondary network function (AMF/SMF) 750 may update the WTRU 710 with the latest SMN/UNSP information.

The procedure 700 may include step 10. At step 10, the WTRU 710 on reception of the updated SMN/UNSP information may re-evaluate the highest priority SMN and if it's not already camped on the highest priority SMN, it may trigger SMN selection as described herein. At this point in the procedure, the WTRU 710 may wait for detection of trigger to start SMN Selection. Examples of what events may be detected by the WTRU 710 and can trigger SMN Selection are provided herein. The WTRU 710 may use the SMN/UNSP information that was received in step 9 to select an SMN, and it may trigger step 5 of this procedure (i.e. Registration procedure with the newly selected SMN).

In certain representative embodiments, the network 730 may transmit information indicating a first SMN and UNSP to a first WTRU and transmit a second information indicating a second SMN and UNSP to a second WTRU. The first SMN and UNSP may be different from the second SMN and UNSP.

In certain representative embodiments, on detection of an SMN selection trigger a WTRU may use the available SMN and UNSP information to start SMN selection and subsequent registration procedure. The SMN selection procedure may involve scanning the radio to find available and desired mobile networks.

In certain representative embodiments, some of the SMN selection triggers whose detection result in the WTRU to start the SMN selection process are as described in the following paragraphs.

Switch On/Power on, depending upon the flag provided in the UNSP information is true i.e. Power on SMN selection is set to True. If the dependent flag “PMN Successful registration” is True, the WTRU may ensure that the registration procedure is successful on PMN before triggering SMN selection and registration on the secondary mobile network.

Trigger from the upper layers e.g. request to establish the MA PDU Session using DualSteer functionality, request to access hosting network (SNPN), slices unavailability on the PMN and corresponding feature is enabled in the UNSP information (i.e. Slice unavailability/rejection on the PMN as the trigger for the SMN selection feature is enabled).

The WTRU may trigger the SMN selection procedure when the coordination function within a WTRU, that manages multi-UE, multi-connectivity functionality, e.g., DualSteer device may have a coordination function to coordinate switching, steering or splitting of a session in a DualSteer device with two UEs/MT with dual subscription.

PMN validity info (Time/location/Service) is met. The time/location/service validity information is met for the successfully registered PMN i.e., the time window is valid, or location is part of valid cells/TACs/TAIs, or service is supported by the network e.g. DualSteer support indicated by the PMN.

Manual selection of the secondary mobile network, triggered by the user/application running on the WTRU.

The WTRU may trigger the SMN selection procedure when it detects that a certain type of application has started in the WTRU. For example, the UNSP information may indicate that the WTRU should trigger the SMN selection procedure when it detects that a certain type of application has started in the WTRU. Detecting that a certain type of application has started may mean that the WTRU detects uplink traffic for the application. This option may be useful when certain applications are known to require or benefit from using the DualSteer feature.

The WTRU may trigger the SMN selection procedure when it detects that a QoE measurement is below a threshold. For example, the UNSP information may indicate that the WTRU should trigger the SMN selection procedure when it detects that a QoE measurement that is associated with a certain application is below a threshold. The UNSP may include the type of QoE measurement, the threshold and the type of application that the policy applies to. Mean Opinion Score (MOS) is an example of a QoE measurement. Packet Loss Rate, a Jitter measurement, delay measurement, a measurement of playback errors, and a measurement of bit rate are other example of measurements that can be compared to a threshold from the UNSP and used to determine whether to trigger SMN selection. This option may be useful when the measurement is known to be indicative of a primary connection that is low is quality and that the application would therefore benefit from using the DualSteer feature.

The WTRU may trigger the SMN selection procedure when it detects that a quality measurement is below a threshold. For example, the UNSP information may indicate that the WTRU should trigger the SMN selection procedure when it detects that a measurement that is associated with the quality of the connection to the primary network is below a threshold. The UNSP may include the type of quality measurement, the threshold and the type of network (e.g. LTE, 5G, 6G, Satellite) that the policy applies to. This option may be useful when the measurement is known to be indicative of a primary connection that is low is quality and that the WTRU may therefore benefit from using the DualSteer feature.

The WTRU may trigger the SMN selection procedure when it based on a trigger from an application. For example, a GUI of an application may present a button to the user for enabling and disabling the DualSteer feature. A user may wish to only enable the feature when the user is of the opinion that the feature may improve the user's experience and when the user believes that the battery level of the WTRU is sufficient for maintaining connections to two networks for a period of time. When the user indicates to the GUI that the DualSteer feature should be enabled or disabled, the GUI Application may invoke an AT Command to inform the MT part that the feature should be enabled or disabled. When the MT part of the WTRU receives an indication that the feature should be disabled, the WTRU may trigger a de-registration procedure. When the WTRU receives an indication that the feature should be enabled, the WTRU may trigger the SMN selection procedure.

The WTRU may trigger the SMN selection procedure based on the notification it received on the primary mobile network connection. This notification could be in the form of a new information element/flag/a bit provided to the WTRU via DL NAS signaling or other signaling means via the connection over the primary mobile network requesting the WTRU to trigger SMN selection procedure as per already delivered SMN and UNSP information. This indication may follow along with the delivery of the SMN and UNSP information.

The WTRU may trigger the SMN selection procedure based on detecting a high network load and/or network congestion on the primary mobile network connection. The detection may be based on network measurements on the WTRU and/or on network load notification from the PMN.

The WTRU may trigger the SMN selection procedure based on determining that the service of a (e.g., non-DS) MA-PDU session is not appropriate. For example, this determination may occur when establishing a MA-PDU session, if a second access is not available. In another example, this determination may occur during the operation of a MA-PDU session, if one of the accesses becomes unavailable (e.g., for a certain duration). Following the registration to the SMN, the WTRU may trigger the modification of the MA-PDU session to become a DualSteer MA-PDU session.

The WTRU may trigger the SMN selection procedure to acquire access to localized networks which allows a WTRU to additionally connect to a localized network to consume content or services which are only available via the localized network.

In certain representative embodiments, if at detection of the SMN selection trigger, if the WTRU does not have SMN or UNSP information, the WTRU performs at least one of the steps described in the following paragraphs.

Trigger a registration update or other UL NAS procedure on the primary mobile network and indicate the PMN that secondary network selection feature is supported. This may prompt the PMN to either indicate back support for the feature along with the SMN and UNSP information or indicate secondary network selection feature not supported for the WTRU. In the case the feature is not supported, the WTRU may reject any triggers for SMN selection.

The WTRU may select a secondary network based on PLMN selection rules. This selection procedure would not consider an SMN/UNSP information since there is no SMN/UNSP information stored in the WTRU. The WTRU may then follow the steps 5 to 8 of the FIG. 6. In case the secondary mobile network provides the SMN/UNSP information as shown in step 8 of FIG. 6, the WTRU may take the latest received information (i.e., SMN and UNSP information) into consideration to decide whether SMN selection and registration on a different SMN is needed.

The WTRU may select the SMN from the list of SMNs present in the SMN information if available and allowable (An allowable SMN is not part of any valid forbidden lists of PLMNs/SNPNs maintained by the WTRU and if the SMN has validity information stored in the SMN information, an allowable SMN would be the one which satisfies the validity conditions i.e. time and location validity is met) using one or more of the following rules—

The WTRU may select the highest priority SMN/access technology combination from the list of the SMNs i.e. the first entry in the list has the highest priority and list of SMNs are stored in the priority order. The Access technology selection for the candidate SMN is based on the WTRU preference.

If the flag “PMN equivalent PLMNs restriction” as per the UNSP information is set to True, the SMN selection may ensure that only SMNs which are part of the equivalent PLMNs to PMN may be considered as selection candidates for SMN selection. The Priority is decided as per the SMN information i.e. first entry has the highest priority.

If the trigger for the SMN selection was because of slice unavailability on the PMN, the SMN selection candidates may be the SMNs which support desired slices (i.e., slices which were not available or rejected on the PMN).

Once the SMN selection has been performed, the WTRU may perform the registration procedure on the selected SMN (i.e. PLMN or SNPN) and the WTRU successfully registers on the SMN if the WTRU was able to find a suitable cell of the SMN to camp on and he registration request from the WTRU has been accepted in the registration area of the cell on which the UE is camped.

In a scenario where the registration procedure on the SMN is not successful (SMN has rejected the registration attempt with fatal reject cause values e.g. N1 mode not allowed, GPRS services not allowed, or other reject causes indicating that the selected SMN cannot provide normal services to the WTRU), the WTRU may restart the SMN selection process and pick up the next available and allowable SMN candidate for SMN selection and registration as per the SMN selection process described herein In certain representative embodiments, if the information “Periodic search and periodic search timer duration” is set to true and available as part of the UNSP information, the WTRU may periodically look for an SMN if not already successfully camped on an SMN. The periodic attempts to find and select an SMN may be performed in the cases provided in the following paragraphs.

After successful registration on the PMN, if the periodic search for SMN is enabled as per the UNSP information “Periodic search and periodic search timer duration”, the WTRU may look for the SMN. The periodicity for this search may be as per the periodic search duration provided as part of the UNSP information.

If the WTRU is limited camped on a secondary mobile network i.e. the WTRU may be camped on any available cell of the secondary mobile network, or registration procedure has been rejected on the camped cell of the SMN. The WTRU may periodically look for a suitable cell/SMN which can provide access to normal services on the secondary mobile network. This periodic search and periodicity of this search is based on the information provided in the UNSP information.

If the WTRU loses the coverage of the suitable camped cell of the SMN, it may look for other available suitable cells from the same SMN. In case it's not able to find any suitable cell of the last registered SMN, it may trigger SMN selection procedure to find other suitable SMNs available in the area as per the SMN information.

If the WTRU is not served by any mobile network i.e. the WTRU is not camped on any suitable cell of the PMN i.e., no coverage scenario, it may periodically make attempts to find a suitable SMN.

In certain representative embodiments, if the feature “Higher priority search for SMN” is set to true and available as part of the UNSP information, the WTRU may periodically look for a higher priority SMN if the camped SMN is not already the highest priority SMN.

The WTRU may ensure that during the initial cell selection process at power on or recovery from lack of coverage it may always try to select the highest priority SMN.

The search for the higher priority SMN may be performed after every successful SMN selection and registration and while the WTRU is in Idle mode (no active RRC connection).

The periodicity for the higher priority search may be based on the higher priority search duration provided in the UNSP information. The WTRU may store this information in the non-volatile memory, or it could be stored in the Elementary Files (EFs) maintained in the USIM.

In certain representative embodiments, the WTRU may have a first connection to the PMN and a second connection to the SMN. For example upon completion of step 7 of the procedure 700 of FIG. 7. The WTRU may next need to determine which traffic flows should be routed via just the PMN, just the SMN, or both the PMN and the SMN.

The WTRU may establish a first PDU Session with the PMN. The WTRU may decide to establish a second PDU session with the SMN and associate the second PDU Session with the same DNN/S-NSSAI combination that is associated with the first PDU Session. The WTRU may include the DNN/S-NSSAI combination in the PDU Session Establishment request message that is send to the SMN. Once the second PDU Session is established, the WTRU may associate the same applications that are associated with the first PDU Session with the second PDU Session. The WTRU may then use ATSSS rules to determine whether each PDU from the applications should be sent over the first PDU Session, the second PDU Session, or both the first and second PDU Sessions.

The WTRU may have used UE/WTRU Route Selection Policy URSP Rules to determine to establish the first PDU Session. The RSD (Route Selection Descriptor) that was used by the WTRU to determine the characteristics of the first PDU Session may also be used to determine the characteristics of the second PDU Session. The RSD of the URSP rule may also include an indication that the PDU Session should be associated with the DualSteer feature. Associating a PDU Session with the DualSteer feature means that the PDU Session should be associated with second PDU Session that is established over a different network.

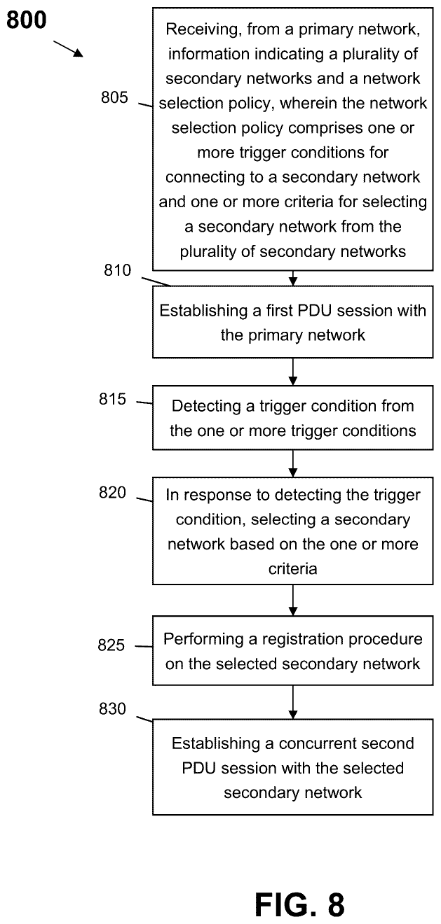

FIG. 8 illustrates a method 800 for selecting a secondary network according to one or more embodiments. The method 800 may be performed by a WTRU such as any of the WTRUs 102 of FIGS. 1A-1D, the DualSteer device 630 of FIG. 6, or WTRU 710 of FIG. 7. The method 800 may include receiving 805, from a primary network, information indicating a plurality of secondary networks and a network selection policy, wherein the network selection policy comprises one or more trigger conditions for connecting to a secondary network and one or more criteria for selecting a secondary network from the plurality of secondary networks. In some embodiments, the receiving 805 may correspond to step 3 of FIG. 7. In some embodiments, the receiving 805 may correspond to step 1 of paragraph 124. The method 800 may further include detecting 815, a trigger condition from the one or more trigger conditions. In some embodiments, the detecting 815 corresponds to step 3 of paragraph [0124]. The method 800 may further include, in response to detecting the trigger condition, selecting 820 a secondary network based on the one or more criteria. In some embodiments, the selecting 820 corresponds to step 4 of paragraph [0125]. The method 800 may further include performing 825 a registration procedure on the selected secondary network. In some embodiments, the performing 825 corresponds to step 5 of paragraph [0126]. The method 800 may further include establishing 830 a concurrent second PDU session with the selected secondary network.

In some implementations, the information indicating a plurality of secondary networks and a network selection policy may be received via a service accept message, a protocol data unit (PDU) session establishment accept message, a PDU session modification response message, a WTRU configuration update Command, a WTRU parameter update request message, a steering of roaming message, registration accept message, or a downlink non-access stratum (DL NAS) signaling message.

In some implementations, the method 800 may include storing the information indicating a plurality of secondary networks and a network selection policy in a non-volatile memory or elementary files (EFs) maintained in an universal subscriber identity module (USIM).

In some implementations, the one or more trigger conditions may comprise at least one of a request to access a hosting network, one or more slices unavailability on the primary network, a condition associated with validity of the primary network, a manual secondary network selection request from a user of the WTRU, detecting that a type of application has started, detecting that a quality of experience (QoE) measurement is below a threshold, detecting that a connection quality associated with the primary network is below a threshold, detecting a high network load and/or network congestion, or a request to use a DualSteer functionality for the first PDU session.

In some implementations, the one or more criteria for selecting a secondary network may comprise at least one of selecting a secondary network supporting slices not available or rejected on the primary network, or selecting a secondary network that is part of equivalent public land mobile networks (PLMNs) to the primary network.

In some implementations, the selected secondary network is a first secondary network, the method 800 may further include determining whether the registration procedure is successful. If it is determined that the registration procedure is not successful, the method 800 may further include selecting a second secondary network, different from the first secondary network, based on the one or more criteria. The method 800 may further include performing a registration procedure on the second secondary network.

In some implementations, the method 800 may further include determining, based on a route selection policy, that the first PDU Session and the second PDU sessions are associated with an application. The method 800 may further include determining, based on an access traffic steering, switching and splitting (ATSSS) rule, whether a PDU associated with the application is transmitted via the first PDU session and/or the second PDU session.

In some implementations, the information indicating a plurality of secondary networks further may comprise an identifier associated with each of the plurality of secondary networks, a priority ranking associated with each of the plurality of secondary networks, a supported access technology associated with each of the plurality of secondary networks, validity information associated with each of the plurality of secondary networks, or a supported network slice associated with each of the plurality of secondary networks.

In some implementations, the method may further include determining whether to perform a periodic search function for a secondary network based on the network selection policy.

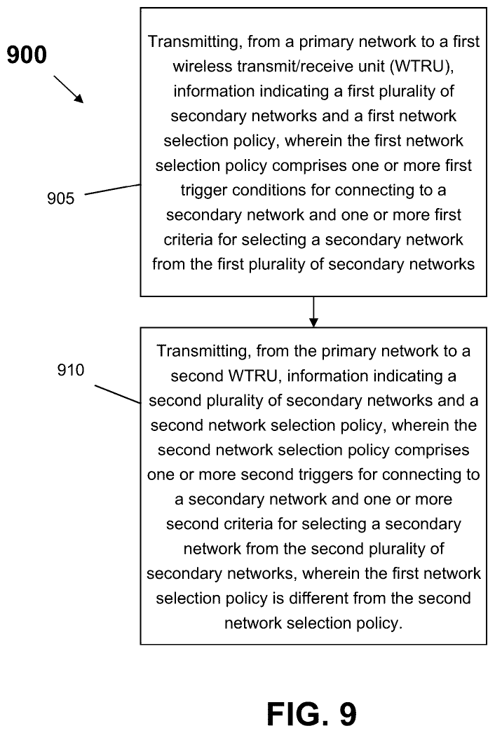

FIG. 9 illustrates a method 900 for establishing network selection policies for a secondary network according to one or more embodiments. The method 900 may be performed by a network such as the network 106 of FIGS. 1A and 1C, network 115 of FIG. 1D, network 610 of FIG. 6 or the network 730 of FIG. 7. The method 900 may include transmitting 905, from a primary network to a first wireless transmit/receive unit (WTRU), information indicating a first plurality of secondary networks and a first network selection policy, wherein the first network selection policy comprises one or more first trigger conditions for connecting to a secondary network and one or more first criteria for selecting a secondary network from the first plurality of secondary networks. The method 900 may further include transmitting 910, from the primary network to a second WTRU, information indicating a second plurality of secondary networks and a second network selection policy, wherein the second network selection policy comprises one or more second triggers for connecting to a secondary network and one or more second criteria for selecting a secondary network from the second plurality of secondary networks, wherein the first network selection policy is different from the second network selection policy. In some embodiments, the first and second network selection policy may have different values for the PMN validity information; PMN equivalent PLMNs restriction (True/False); PMN Successful registration (True/False); periodic search and periodic search timer duration (True/False); power on SMN selection (True/False); higher priority search for SMN, feature enabled/disabled; slice unavailability/rejection on the PMN as the trigger for the SMN selection feature enabled/disabled; DualSteer upgrade for non-DS MA-PDU session enabled/disabled.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), comprising:
receiving, from a primary network, information indicating a plurality of secondary networks and a network selection policy, wherein the network selection policy comprises one or more trigger conditions for connecting to a secondary network and one or more criteria for selecting a secondary network from the plurality of secondary networks;
establishing a first PDU session with the primary network;
detecting a trigger condition from the one or more trigger conditions;
in response to detecting the trigger condition, selecting a secondary network based on the one or more criteria;
performing a registration procedure on the selected secondary network; and
establishing a concurrent second PDU session with the selected secondary network.

2. The method of claim 1, wherein the information is received via a service accept message, a protocol data unit (PDU) session establishment accept message, a PDU session modification response message, a WTRU configuration update Command, a WTRU parameter update request message, a steering of roaming message, registration accept message, or a downlink non-access stratum (DL NAS) signaling message.

3. The method of claim 1, wherein the one or more trigger conditions comprise a manual secondary network selection request from a user of the WTRU.

4. The method of claim 1, wherein the one or more trigger conditions comprise at least one of detecting that a type of application has started, or detecting that a quality of experience (QoE) measurement is below a threshold.

5. The method of claim 1, wherein the one or more trigger conditions comprise at least one of a request to access a hosting network, one or more slices unavailability on the primary network, a condition associated with validity of the primary network, detecting that a connection quality associated with the primary network is below a threshold, detecting a high network load and/or network congestion, or a request to use a DualSteer functionality for the first PDU session.

6. The method of claim 1, wherein the one or more criteria comprise at least one of selecting a secondary network supporting slices not available or rejected on the primary network, or selecting a secondary network that is part of equivalent public land mobile networks (PLMNs) to the primary network.

7. The method of claim 1, wherein the selected secondary network is a first secondary network, the method further comprising:
determining whether the registration procedure is successful;
if it is determined that the registration procedure is not successful, selecting a second secondary network, different from the first secondary network, based on the one or more criteria; and
performing a registration procedure on the second secondary network.

8. The method of claim 1, further comprising:
determining, based on a route selection policy, that the first PDU Session and the second PDU session are associated with an application; and
determining, based on an access traffic steering, switching and splitting (ATSSS) rule, whether a PDU associated with the application is transmitted via the first PDU session and/or the second PDU session.

9. The method of claim 1, wherein the information further comprises an identifier associated with each of the plurality of secondary networks, a priority ranking associated with each of the plurality of secondary networks, a supported access technology associated with each of the plurality of secondary networks, validity information associated with each of the plurality of secondary networks, or a supported network slice associated with each of the plurality of secondary networks.

10. The method of claim 1, further comprising:
determining whether to perform a periodic search function for a secondary network based on the network selection policy.

11. A method for establishing network selection policies comprising:
transmitting, from a primary network to a first wireless transmit/receive unit (WTRU), information indicating a first plurality of secondary networks and a first network selection policy, wherein the first network selection policy comprises one or more first trigger conditions for connecting to a secondary network and one or more first criteria for selecting a secondary network from the first plurality of secondary networks; and
transmitting, from the primary network to a second WTRU, information indicating a second plurality of secondary networks and a second network selection policy, wherein the second network selection policy comprises one or more second triggers for connecting to a secondary network and one or more second criteria for selecting a secondary network from the second plurality of secondary networks;
wherein the first network selection policy is different from the second network selection policy.

12. A wireless transmit/receive unit (WTRU) comprising:
a processer; and
a transceiver coupled to the processer, wherein the WTRU is configured to:
receive, from a primary network, information indicating a plurality of secondary networks and a network selection policy, wherein the network selection policy comprises one or more trigger conditions for connecting to a secondary network and one or more criteria for selecting a secondary network from the plurality of secondary networks;
establish a first PDU session with the primary network;
detect a trigger condition from the one or more trigger conditions;
in response to detecting the trigger condition, select a secondary network based on the one or more criteria;
perform a registration procedure on the selected secondary network; and
establish a concurrent second PDU session with the selected secondary network.

13. The WTRU of claim 12, wherein the information is received via a service accept message, a protocol data unit (PDU) session establishment accept message, a PDU session modification response message, a WTRU configuration update command, WTRU parameter update request message, steering of roaming message, registration accept message, or downlink non-Access stratum (DL NAS) signaling message.

14. The WTRU of claim 12, wherein the one or more trigger conditions comprise at least one of a manual secondary network selection request from a user of the WTRU, detecting that a type of application has started, or detecting that a quality of experience (QoE) measurement is below a threshold.

15. The WTRU of claim 12, wherein the one or more trigger conditions comprise at least one of a request to access a hosting network, one or more slices unavailability on the primary network, a condition associated with validity of the primary network, a manual secondary network selection request from a user of the WTRU, detecting that a type of application has started, detecting that a quality of experience (QoE) measurement is below a threshold, detecting that a connection quality associated with the primary network is below a threshold, detecting a high network load and/or network congestion, or a request to use a DualSteer functionality for the first PDU session.

16. The WTRU of claim 12, wherein the one or more criteria comprise at least one of selecting a secondary network supporting slices not available or rejected on the primary network, or selecting a secondary network that is part of equivalent public land mobile networks (PLMNs) to the primary network.

17. The WTRU of claim 12, wherein the selected secondary network is a first secondary network, and the WTRU is further configured to:
determine whether the registration procedure is successful;
if it is determined that the registration procedure is not successful, select a second secondary network, different from the first secondary network, based on the one or more criteria; and
perform a registration procedure on the second secondary network.

18. The WTRU of claim 12, wherein the WTRU is further configured to:
determine, based on a route selection policy, that the first PDU Session and the second PDU session are associated with an application; and
determine, based on an access traffic steering, switching and splitting (ATSSS) rule, whether a PDU associated with the application is transmitted via the first PDU session and/or the second PDU session.

19. The WTRU of claim 12, wherein:
the information further comprise at least one of an identifier associated with each of the plurality of secondary networks, a priority ranking associated with each of the plurality of secondary networks, a supported access technology associated with each of the plurality of secondary networks, validity information associated with each of the plurality of secondary networks, or a supported network slice associated with each of the plurality of secondary networks.

20. The WTRU of claim 12, wherein the WTRU is further configured to:
determine whether to perform a periodic search function for a secondary network based on the network selection policy.
